(19) United States
(12) Patent Application Publication
(10) Pub. No.: US 2016/0080438 A1
(43) Pub. Date: Mar. 17, 2016

(54) Method and Apparatus for Tile-Based Geographic Social Interaction

(71) Applicant: Place Pixel Inc., New York, NY (US)

(72) Inventor: Scott Frank Liang, New York, NY (US)

(21) Appl. No.: 14/818,135

(22) Filed: Aug. 4, 2015

Related U.S. Application Data
(60) Provisional application No. 62/032,979, filed on Aug. 4, 2014.

(51) Int. Cl. H04L 29/06; G06F 17/30; G06F 3/0481; G06F 3/0484

(52) U.S. Cl. CPC H04L 65/403; G06F 3/04842; G06F 17/30029; G06F 3/04812; G06F 2203/04806

(57) ABSTRACT

Tile-based geographic discussion platform may be provided through a location-aware map overlaid with a grid comprising a plurality of tiles. Each tile may be linked to a unique portion of the map and provide location-specific information to the user. A user may provide input with respect to a tile.

### CROSS-REFERENCE TO RELATED APPLICATION

This application claims priority to U.S. Provisional Patent Application 62/032,979 entitled “Method and Apparatus for Tile-Based Geographic Discovery” filed Aug. 4, 2014, which is hereby entirely incorporated herein by reference.

### COPYRIGHT NOTICE

This application contains material that is subject to copyright protection. Such material may be reproduced exactly as it appears in Patent and Trademark Office patent files or records. The copyright owner otherwise reserves all rights to such material.

### FIELD

The disclosed method and apparatus generally relate to a method and apparatus for geographically-based social interaction and discovery.

### BACKGROUND

A variety of location-based systems allow users to verify their locations, or to use their locations for the purpose of interacting within a social network, or to “check in” to particular locations, including particular venues such as retail locations, recreation areas, discrete points of interest, or other discrete locations. Such location-based systems may allow users to interact with other users through social networks, to find other discrete points of interest, and/or to post comments, replies and tags in connection with particular points of interest. Such systems generally use a marker-based method to identify locations on a map. Generally displayed on a user interface (UI), the markers denote the pinpoint locations of phenomena, e.g., businesses, objects, etc., analogous to sticking a pin on a physical map. However, such an approach involves an un-scalable user interface, and often results in redundant markers. Once a certain number of phenomena are reached, the UI becomes essentially unusable, and the (spatial) extents of the phenomena cannot be adequately documented. The use of markers thus frames the discussion around the specific phenomena in a manner that limits user engagement, e.g., “here is a restaurant, now talk about it.”

Furthermore, such systems do not permit user engagement or social network interaction with respect to broader geographic regions of interest. User engagement with a broader geographic region may permit users to better evaluate the overall desirability of certain areas of, for example, an urban environment, rather than rely on disparate user comments or “check ins” for a discrete point of interest to evaluate regional desirability. Existing systems attempt to overlay various shapes over a map in connection with markers, thus yielding a visually-cluttered and confusing user interface. Moreover, such systems do not allow users to discover the preferences of another user or group of users with respect to the geographic region, or to adequately share preferences through a social network.

Thus, there exists a need for a method and apparatus for allowing users of a location-based system to socially interact, discover and engage at a regional geographic level.

### SUMMARY

A method of geographic social interaction may comprise providing a map representing a geographic area; overlaying the map with a grid, the grid comprising a plurality of tiles, each tile being associated with a unique portion of the geographic area; and receiving input from a first user in connection with one of the plurality of tiles.

A method of geographic discovery may comprise providing a map representing a geographic area; overlaying the map with a grid, the grid comprising a plurality of tiles, each tile being associated with a unique portion of the geographic area; detecting a location of a first user; identifying the location of the first user on the map with respect to a first user tile, the first user tile being one of the plurality of tiles; receiving a first input from a first user in connection with a first selected tile, the first selected tile being one of the plurality of tiles; and in response to the first input, providing first selected tile information to the first user in response to the first input, the first selected tile information comprising information regarding the portion of the geographic area associated with the first selected tile.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates one embodiment of a system that may be used to provide tile-based geographic discovery.

FIG. 2 illustrates one embodiment of a grid overlaying a map to form tiles or “place pixels.”

FIG. 3 illustrates one embodiment of conceptual overlay of a grid on a map and tile aggregation.

FIG. 4 illustrates one embodiment of a comment field.

FIG. 5 illustrates one embodiment of tile visualization options.

FIG. 6 illustrates one embodiment of visualization of user votes.

FIGS. 7, 8, 9 and 10 illustrate one embodiment of a tile aggregation and disaggregation that may occur while zooming.

FIG. 11 illustrates one embodiment of various filter settings.

FIGS. 12 and 13 illustrate one embodiment of filter setting icons.

FIGS. 14, 15 and 16 illustrate various embodiments of search fields.

FIG. 17 illustrates one embodiment of a user profile screen.

FIG. 18A illustrates one embodiment of a friend feed.

FIG. 18B illustrates one embodiment of a comment feed.

FIG. 19 illustrates one embodiment of a tile list.

FIGS. 20 and 21 illustrate one embodiment of differences between an all-user and single-user viewport mode.

FIGS. 22, 23A and 23B illustrate various embodiments of tile information screens.

FIG. 24 illustrates one embodiment of a pixel preview screen.

FIG. 25 illustrates another embodiment of a pixel preview screen.

FIG. 26 illustrates an embodiment of a filtered pixel map.

FIGS. 27, 28, 29 and 30 illustrate an example of “lighting up” a pixel map over time.

FIGS. 31A, 31B and 31C illustrate one embodiment of how a user may interact with a tile-based geographic discovery system.

FIG. 32 illustrates one embodiment of a data process flow in a tile-based geographic discovery system.

FIG. 33 illustrates an example of feature grouping.

FIG. 34 illustrates one embodiment of screen sequences arising from user interaction.

FIG. 35 illustrates one embodiment of screen sequences arising from user searching and/or filtering.

### DETAILED DESCRIPTION

In some embodiments, a location-based system may be provided in connection with a service that allows users to discuss geographic regions of interest and socially engage at a regional geographic level. The service may also allow users to remain informed and up-to-date regarding geographic areas of interest. The service may further allow users to discover and explore geographic regions through a variety of search and filter functions.

As described in more detail below, the system may allow users to select and explore geographic regions of interest, post a comment using text and/or media, reply to user comments, upvote and downvote the geographic regions of interest, upvote and downvote a comment and/or reply, provide tile information, provide various indicia of user sentiment and modes of interaction, such as symbols, emoji, badges and/or stickers, and/or ‘follow’ other users, among other things. The system may thus provide a geographically-focused platform to allow users to accomplish various social and curation tasks, such as announce (e.g., express themselves, promote something, leave a tip), ask (e.g., seek an answer from another user or make a request), browse (e.g., see what might be of interest in areas around the user), and search (e.g., find specific items or points of interest).

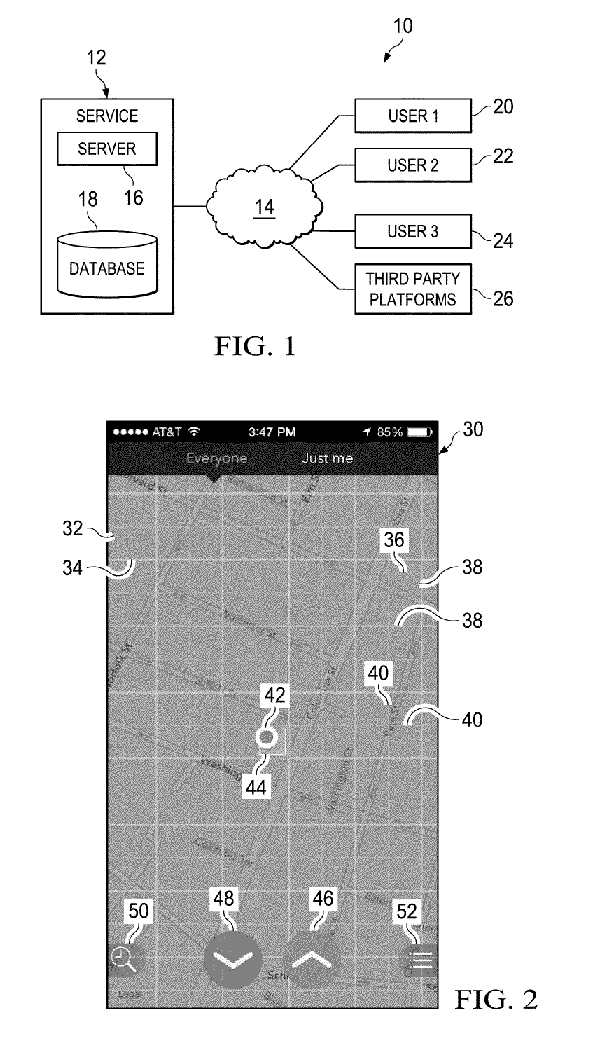

The system may thus comprise a distributed network having one or more computing devices in communication. FIG. 1 illustrates one embodiment of a location-based system. In the embodiment of FIG. 1, the system 10 comprises a service 12 implemented over a distributed network 14. The service 10 may comprise a server 16 in communication with a database 18. The service 10 may provide data and services to one or more users 20, 22, 24 through a software application installed on a location-aware mobile device of the user. The service 10 may integrate data and services from third-party platforms 26, such as social networks, online user reviews, search engines, government databases, cloud-based storage platforms, online content-creation and/or content-delivery platforms, travel advisory sites and advertisers.

In some embodiments, a discussion platform may provide a client software application that a user may download and install on a location-aware computing device, such as an Apple IPHONE® mobile communication device. The application may allow a user to establish a user account by providing identifying information, such as an email address and password. In some embodiments, the application may allow a user to establish a user account using information from a social media account. In such embodiments, for example, the service may allow a user to establish, and thereafter access, a user account by linking to, say, a FACEBOOK® or TWITTER® social media account. The service may allow the user to provide the user's name, address, age, location, relational status, advertising preferences, photographs, and other user-related information. User account information may be stored and organized in database such as database 18.

The application may further provide a graphical user interface comprising a map overlaid with a relatively transparent grid. As may be seen in the exemplar application as displayed on the screen 30 of a mobile communications device (FIG. 2), location-aware mapping software, such as GOOGLE® Maps, may be used to provide an underlying map 32. A grid 34 comprising a plurality of tiles 36 or “place pixels” may be provided over the map 32 such that each tile 36 corresponds to a particular geographic region of the map 32. Each tile 36 may be given a tile name, such as a unique identifying code, tag or number that links the tile to a particular geographic region of a map.

In some embodiments, the tiles 36 may initially comprise a substantially gray or neutral shade or color, and may be separated by major grid lines 38 and minor grid lines 40 of a different shade or color, or of no color or shade at all. In other embodiments, the tiles 36 may simply be defined by the gridlines, i.e., the tiles may be fully transparent, or ‘clear.’

As may be seen in the embodiment of FIG. 2, a user's location 42 may be shown on the map 32 with respect to the grid 34. The tile 44 in which the user is located may be highlighted by a thickened border, or coloration different from that of surrounding tiles, or shading contrast, or animation, symbology, temporary tile magnification, or any suitable visual indication of user location with respect to the grid 34. In the embodiment of FIG. 2, the grid 34 comprises square tiles; however, a grid may comprise any suitably regular and scalable array of geometric shapes, such as rectangles, triangles, hexagons and the like. Similarly, the grid lines may comprise any suitable visual tile divider, and may be of any suitable thickness, shade or color.

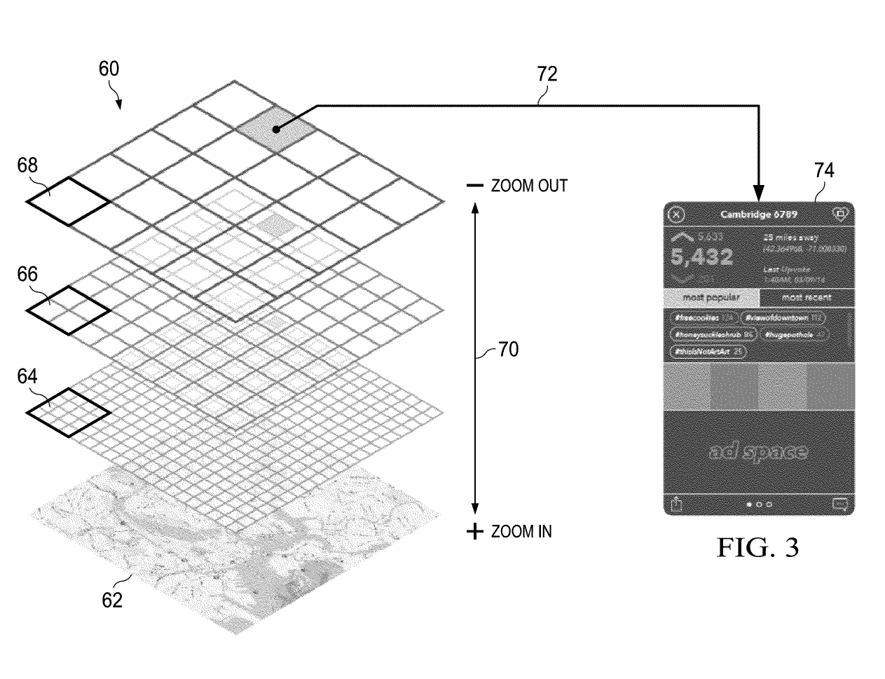

FIG. 3 illustrates conceptually how a grid 60 may overlay a map 62. In the embodiment of FIG. 3, each base tile 64 may represent a geographic area of 28 meters×28 meters. Of course, other area dimensions may be used. As is explained in further detail below, two or more base tiles 64 may be aggregated, depending on the level of magnification 70, or “zoom” level. In the embodiment of FIG. 3, sixteen base tiles 64 may be aggregated into four parent tiles 66 at one zoom level (e.g., representing a geographic area of 56 meters×56 meters), and further aggregated into one super tile 68 at another zoom level (e.g., representing an area of 112 meters×112 meters). Conversely, while zooming in toward the map, a tile may divide and subdivide into multiple tiles. As is also explained in further detail below, each place pixel (whether a base tile, or parent tile or some other aggregation of tiles) may be linked 72 to one or more tile windows 74 containing a variety of information, whether from the user, from the service, from a third party, or any combination thereof, such as user input information, third party content (such as from social networks and user reviews), advertising, photographs, tags, location information, time and date information, distance information, user sentiment information and other such information, and aggregations and permutations thereof. On a touch-screen, for example, such information may be accessed by tapping on a tile.

Returning to the embodiment of FIG. 2, the application may present a user with an ‘upvote’ ( [symbol] ) input button 46 and a ‘downvote’ ( [symbol] ) input button 48. The buttons 46, 48 may be colored or shaded or otherwise visually distinguished from the grid. For example, the upvote button 46 may be colored blue, and the downvote button 48 may be colored red. Tapping the blue button ‘upvotes’ the tile that the user is interested in (such as the tile occupied by the user or another tile) to signify a favorable user sentiment; tapping the red button ‘downvotes’ it to signify an unfavorable user sentiment. As a user explores a geographic region of interest, the user may indicate sentiment or impression about the location in which the user currently exists, or another location, whether favorable or unfavorable. As various tiles are upvoted or downvoted, the grid 34 may gradually change from a neutral shade to a more colorful and vibrant array of tiles 32 that indicate to a user where the user has been, and shows in a more regional fashion the user's sentiment regarding various areas of the geographic region shown on the screen.

Other input methods may be used in addition to or as alternatives to the upvote and downvote buttons. For example, a scoring method, e.g., selecting a number indicating preference along a scale 1-3, or check-ins may be used to indicate user sentiment about the user's location or another location.

In other embodiments, one or more tiles, or all tiles, may not allow a user to vote on the tile, but rather only on information or activity contained in or linked to the tile, such as comments and replies. For example, a tile itself may be neutral, but shaded, colored or highlighted to represent a magnitude of activity or relevance to a user. In some embodiments, a tile may serve primarily as a container for activity and/or information occurring within its bounds.

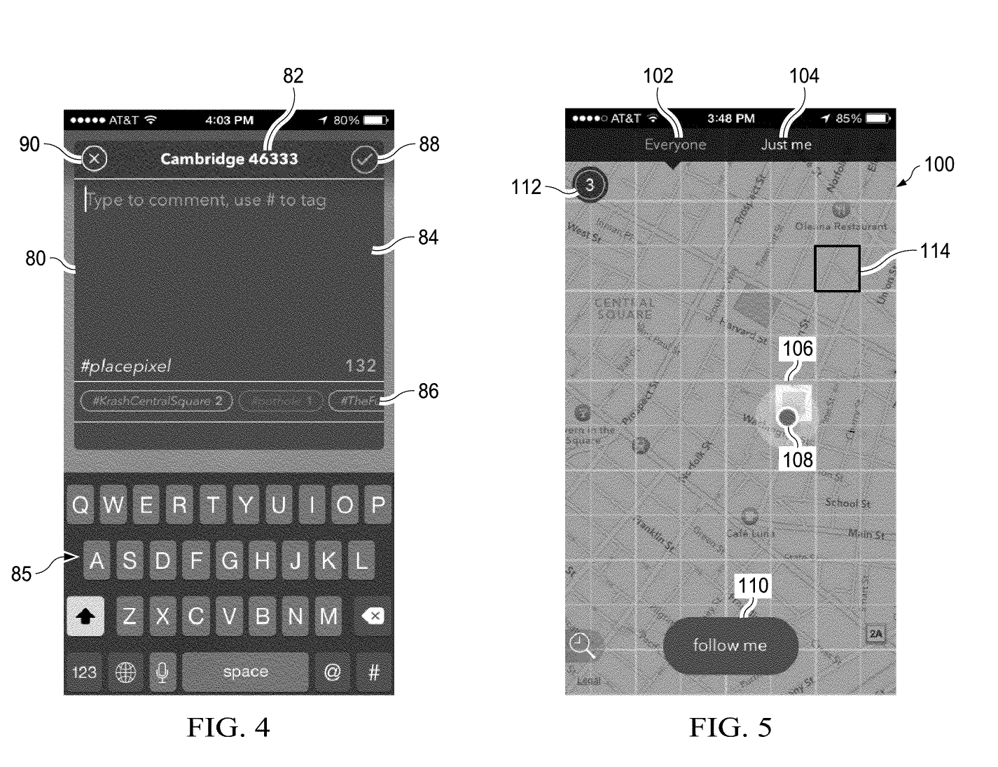

Upon receiving an indication of user sentiment, e.g., an upvote, the application may provide the user with further user input options via a window, such as the exemplar window 80 of FIG. 4. A tile name 82 (shown as ‘Cambridge 46333’ in the example of FIG. 4) may be provided at the top of the window 80 to indicate which tile is associated with the user's location. The window 80 may provide a field 84 in which the user may type comments, replies or #tags (hashtags) using a keyboard 85, and may provide the user with a selection of ‘quick-tags’ 86 based on the history of the tile and the characteristics of the user. Quick-tags 86 may also correspond to tags provided by the underlying map software, if any. In some embodiments (not shown in FIG. 4), a user may attach a photo or other imagery to the tile comment or reply, and further share the comment or reply and photo with other users through social networks (e.g., by providing an icon linked to a social media network, such as Facebook or Twitter). Tapping the checkmark icon 88 may register an upvote and link the comments/replies/imagery to the tile. Upon registration, the application may send the comment and photo to the service database for storage in connection with the user account. An ‘X’ icon 90 may be provided to allow a user to cancel a comment or reply for that tile. In other embodiments, a user may comment by adding a question, or a response to another user's question, or a link to other content (e.g., to a third-party site), or a symbol representing a status, sentiment, physical item, building, service or other point of interest.

As may be seen in the embodiment of FIG. 5, the ‘Everyone’ label 102 and ‘Just me’ label 104 at the top of the screen 100 allow users to choose from which source the tile visualizations come: the activity of all users, or of only the user. In some embodiments, users may vote only in the tiles 106 that they occupy. Thus, when a user zooms or pans away from his or her location 108, the voting buttons (such as shown in FIG. 2) may transform into a ‘follow me’ or ‘find me’ button 110 to place the user's location on the screen 100 again. In other embodiments, the voting buttons may remain, but may change color to indicate that the user may be voting on or with respect to a tile other than the user's tile. The screen 100 may further indicate the current zoom level 112 (shown as level 3 in the upper left corner of FIG. 5). As may be seen in FIG. 5, although being zoomed out, the tiles 114 are larger due to tile aggregation techniques described in further detail below. Generally, zoom level one may be designated as the lowest zoom level (i.e., the zoom level showing the first map resolution).

In some embodiments, alternative map visualizations may be employed, such as twisting/rotating and 3D perspectives. For 3D perspectives (similar to the perspective of FIG. 3), the tiles may be transformed into columns, or may be given a ‘thickness,’ or may ‘float’ above or below the base map. In some embodiments, ‘floating’ tiles may be ‘tethered’ to the base map with z-axis grid lines so that users may better visualize the bounds of the tile with respect to the base map. The columns may comprise varying heights, colors, animations, shadings, and transparencies to further convey information. For example, a column corresponding to a tile receiving more favorable sentiment or popularity may be taller or more prominent than a column corresponding to a less favorably-marked or popular tile. Tile sizing may be dynamic, based on tile aggregation techniques.

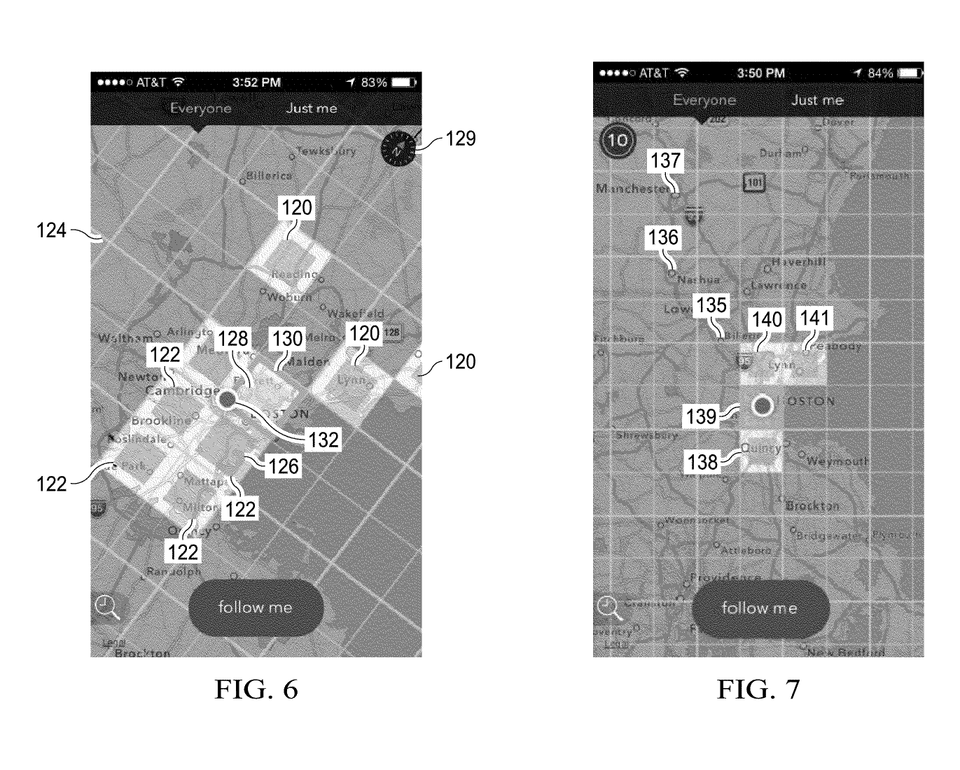

In the embodiment of FIG. 6, for example, blue tiles 120 represent upvoted tiles and red tiles 122 represent downvoted tiles. The intensity of the color may be used to represent the quantity or proportion of upvotes or downvotes, and the size of the tile within the grid 124 may represent the total number of votes the tile has received in relation to other tiles within a given viewport or geographic area. For example, a red tile 126 may be larger (e.g., fill more of the grid space) than the other red tiles 122 to indicate more unfavorable sentiment than that received for the other red tiles 122. A compass 129 may be provided on the screen to indicate map orientation. As various tiles change shape and color, the user-occupied tile 128 may be visually indicated, such as by a thickened grid border 130. The user's location 132 with respect to that tile 128 may also be indicated.

FIGS. 7-10 illustrate a series of screens that demonstrate how the tiles may divide upon zooming in, and how the tiles may aggregate upon zooming out. In this embodiment, when zooming in, one tile may split into four; when zooming out, four tiles may converge into one. This feature may ensure that the tiles fall within an on-device size range that is legible to (and touchable by) the user. Each aggregate tile is visualized to reflect the information entered into the numerous tiles that it represents. Any suitable degree of aggregation may be used, depending on base tile size, tile shape and/or UI bounds. For example, nine square base tiles may be aggregated into one parent tile. Or, twenty-five tiles may aggregate into one tile, and so forth. In other embodiments, the tile shape may change upon aggregation. For example, a 3×2 array of square tiles may aggregate into a single rectangular parent tile. Conversely, when user zooms in, a parent tile may dis-aggregate into two or more tiles. Those dis-aggregated tiles may themselves be parent tiles, which may, upon further zooming in, further dis-aggregate into other parent tiles or base tiles, depending on magnification level.

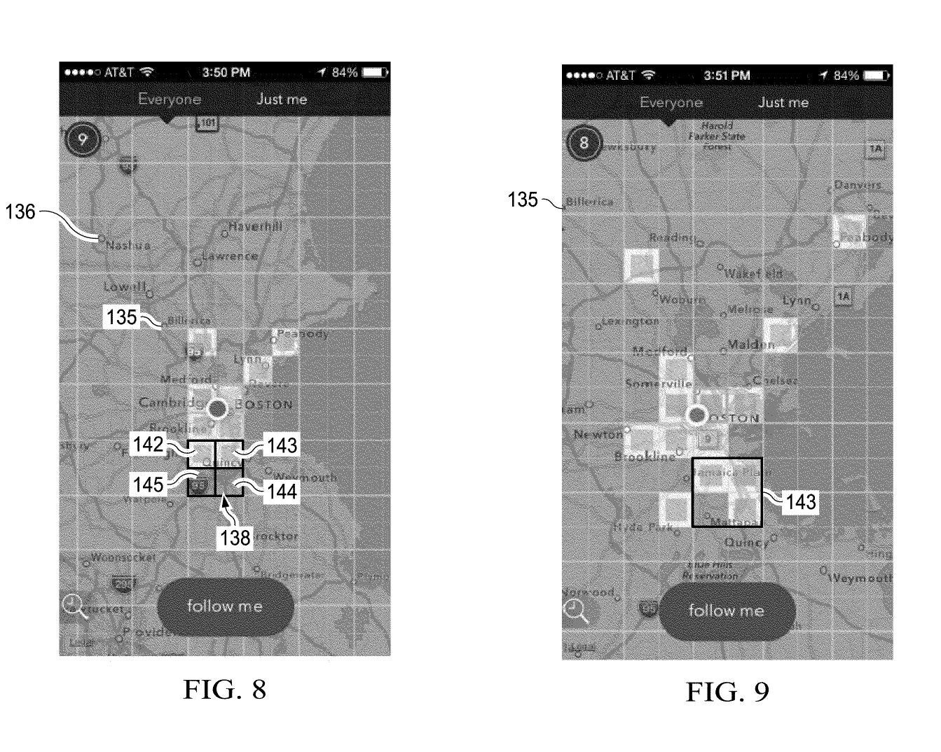

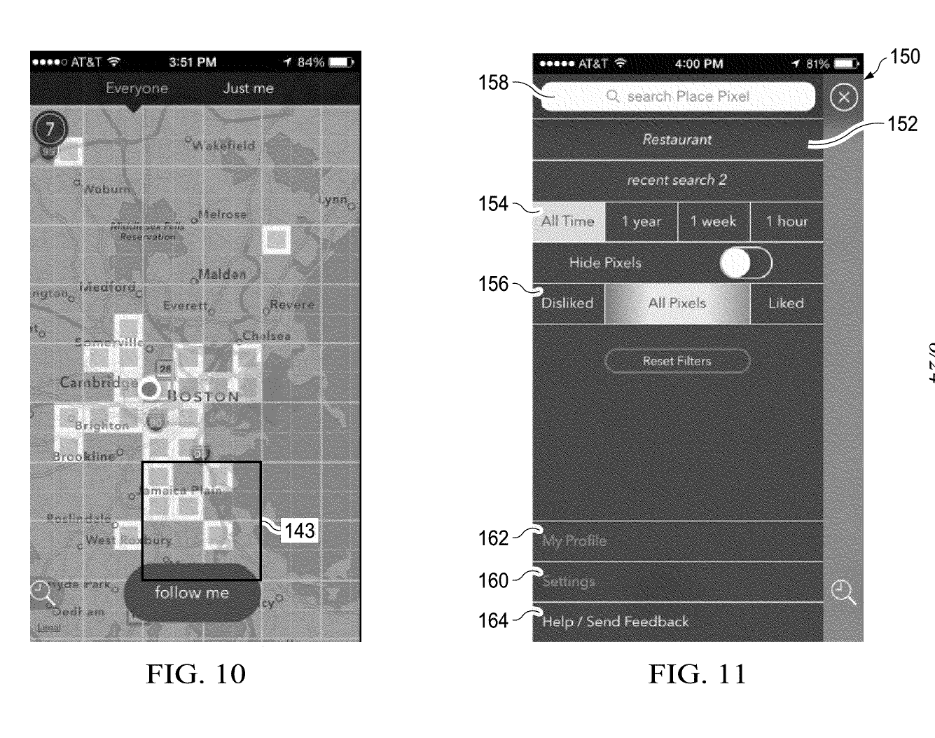

In the example of FIGS. 7-10, a user may zoom in and out of the Boston (Mass.) area. At zoom level 10, the user may see Boston and several surrounding cities, e.g., Billerida 135, Nashua 136 and Manchester 137. In this example, four place pixels 138, 139, 140 and 141 may be seen for which votes or other user inputs have been made. As the user zooms in, the tiles 138, 139, 140 and 141 may begin to grow and divide. Tile 139 may indicate the user location. At zoom level 9 (FIG. 8), a user may still see Nashua and Manchester, but those cities may be closer to the edge of the viewport. Each of the four tiles 138, 139, 140 and 141 may disaggregate into four tiles. Thus, for example, tile 138 may split into four tiles 142, 143, 144 and 145. At zoom level 8 (FIG. 9), Nashua and Manchester may be zoomed out of the viewport, and Billerica may be at the viewport edge. At that zoom level, tile 143 may subdivide into four more tiles, and that subdivision may continue at further zoom levels, such as at zoom level 7 (FIG. 10).

With reference again to FIG. 2, when a user taps the filter settings icon 50, the application may provide a screen displaying various user options. An exemplar screen is illustrated in the embodiment of FIG. 11. The screen 150 may allow the user to toggle the visibility of the tiles according to certain criteria, such as categories 152, time frames 154, values, and pixel preferences 156, and more. The screen may also enable the user to search 158 for specific locations, categories, and #tags, among other information. From this screen 150, the user may also access application settings 160, his or her user profile 162, and ways to obtain help/send feedback 164. In other embodiments, suggestions and/or recommendations may be presented to a user. For example, user categories of content or individual content may be provided to the user. Such content may be provided based on a variety of criteria, such as user demographic information, previous user activity and location.

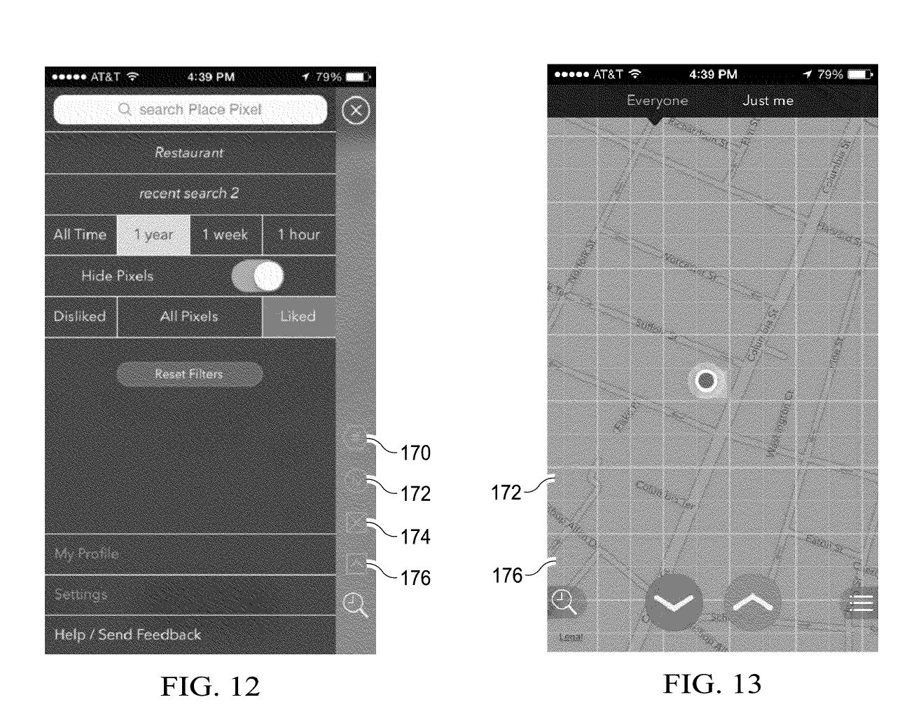

As may be seen FIGS. 12 and 13, user filter selections may be shown on a screen (FIG. 12). Depending on user selection, one or more icons may be shown on the right side bar, such as a tag icon 170, a time icon 172, a “hide pixel” icon 174 and a user sentiment filter icon 176 (shown in FIG. 12 as an upvote or ‘liked’ filter icon; a downvote or ‘disliked’ filter icon may have a down [symbol] arrow instead of an up [symbol] arrow). As may be seen in FIG. 13, those icons may remain displayed on the screen when the user returns to a map view screen to remind the user which filters are active. In the embodiment of FIG. 13, only the time and sentiment filter icons are displayed. If the “hide pixels” option is selected, then no grid will be shown when the user returns to a map view screen and the “hide pixels” icon 174 may be shown.

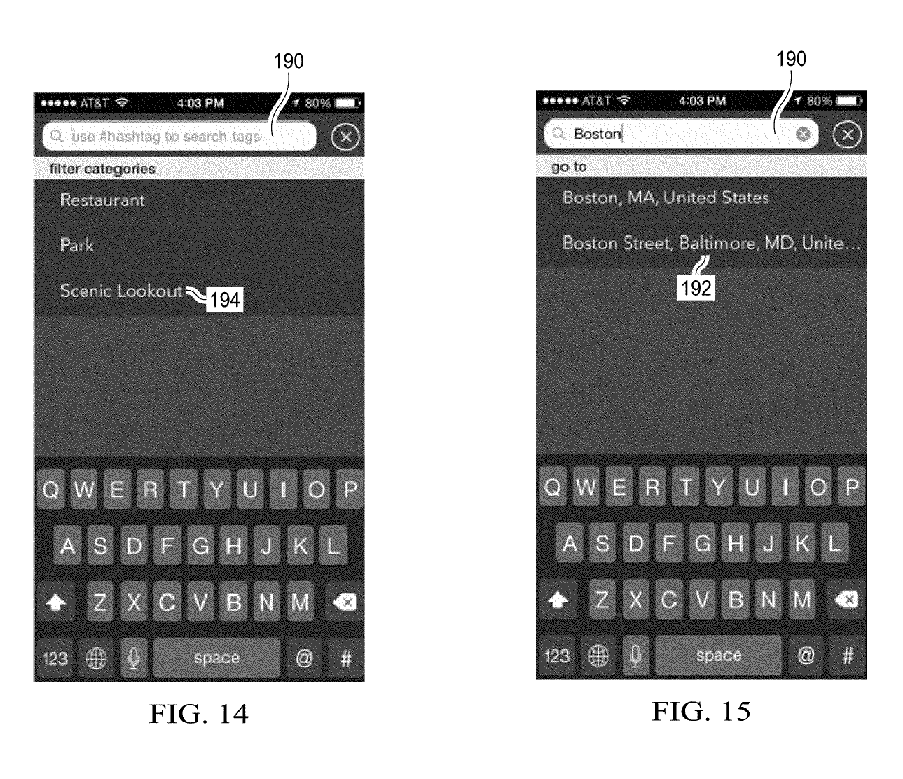

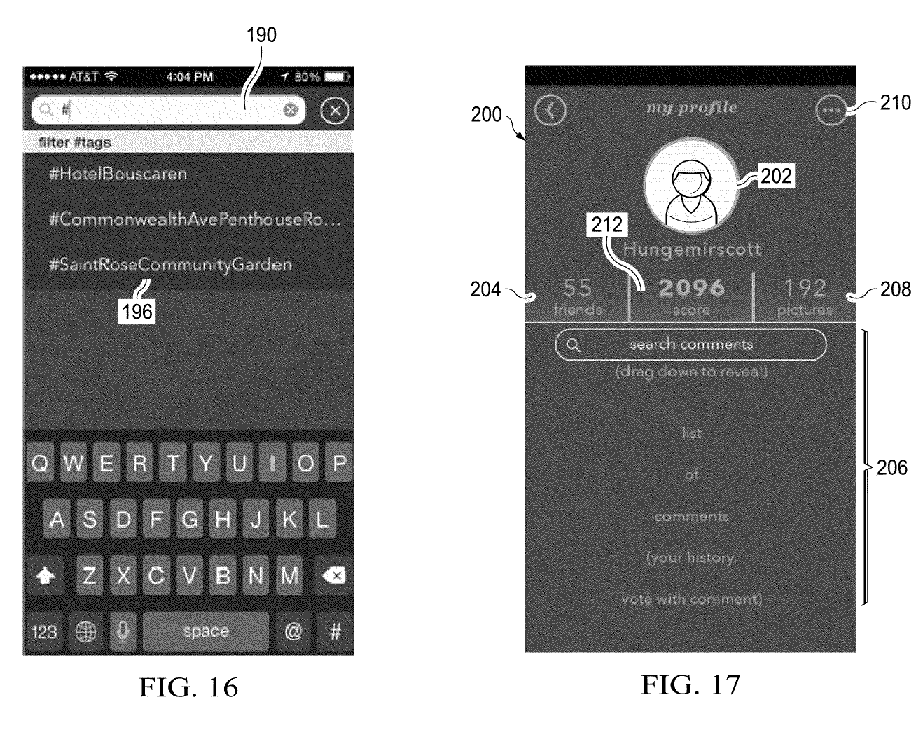

As may be seen in the embodiment of FIGS. 14-16, a user may use a search field 190 to search using a variety of criteria, such as by location 192, by category 194, by #tag 196, text string, photo description, and more. A user may further input combinations of entries, e.g., “safe park,” to find more relevant information. In yet other embodiments, natural language or Boolean search algorithms may provide users with search techniques. As may be seen in FIG. 15, various location results may be displayed, each of which may, by tapping on the location, take the user to that location on the map. As may be seen in FIG. 16, entering specific tags may allow for greater search precision.

FIG. 17 illustrates an embodiment of a user profile screen 200 from which a user may manage his or her images 202, friends 204, past content 206, pictures 208 and additional settings 210, in addition to viewing his or her score/statistics in relation to other users. The user profile may be used to provide a spectrum of gamification that may be used to encourage user interaction with the application by fostering friendly competition and cooperation. This may include presenting missions, leaderboards, scores 212, badges, currency, awards, avatars, and the like. In some embodiments, the discussion platform may allow users to purchase game- or user-related virtual items or access rights, such as customized location beacons, avatars, extended-character comments, higher data storage capacity (such as for photos and videos), and access to certain data (such as map metadata or map filters).

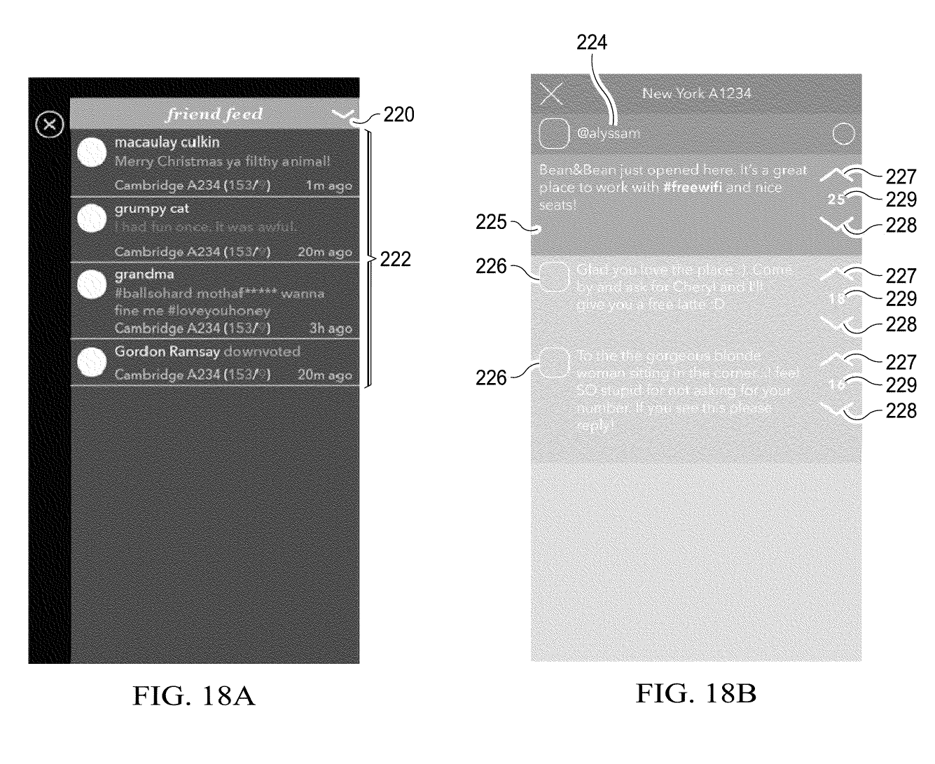

FIG. 18A illustrates an embodiment of a friend feed 220 that the service may make available to a user through the application. Comments and/or replies by other users of the service or by users of other social networks may be provided in a list 222, and may be provided based on a tile, category, image, and/or other information. FIG. 18B illustrates an example of how comments and replies may be organized. A user 224 may provide a comment 225, and replies 226 may be shown underneath in a different color or indentation. The comment 225 and/or replies 226 may be voted on using upvote 227 symbols and downvote 228 symbols. In some embodiments, the number of votes 229 may be tallied. In some embodiments, the system may detect certain text input, such as ‘#’, ‘?’ or ‘:’, and reformat the text or attach a symbol or otherwise provide a special visualization for the text content. For example, a post ending with a question mark may have a question mark symbol appended to it.

In other embodiments, a “following” content feed may be provided. For example, a user may subscribe to a particular tile, so that the content feed may include any activity or information occurring within the tile. In some embodiments, a user may select one or more “home” tiles, such as a tile in which the user lives or works. A user may subscribe to such a “home” tile to see what activity and/or information may be occurring in or linked to that tile. Such content could comprise, for example, restaurant opening announcements, safety alerts, coupons, advertisements, event details, and the like.

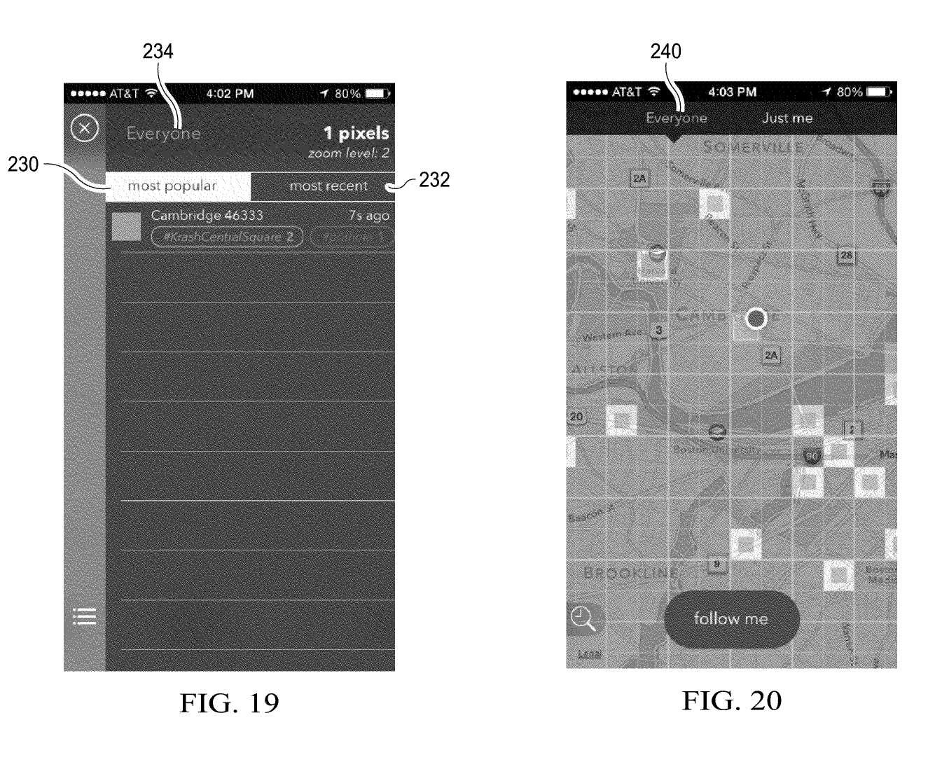

With reference again to FIG. 2, the tile list icon 52 may be tapped by a user to show a list of all or some of the tiles displayed in the current viewport. Such a list may be configured as shown in the embodiment of FIG. 19. In this embodiment, the tiles may be sorted by popularity 230 and recent activity 232. In this embodiment, tags from all users 234 may be displayed. Tapping on a list item may open the respective tile window (such as the tile window 74 of FIG. 3 or 22).

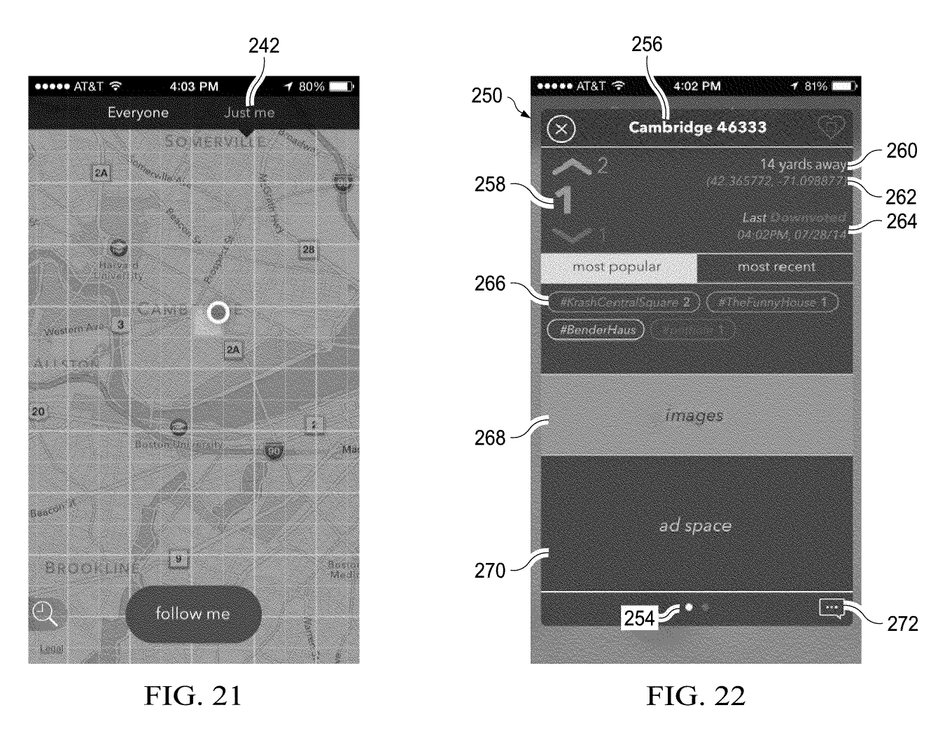

The exemplar map view of FIGS. 20 and 21 compare an ‘everyone’ all users display mode 240 (FIG. 20) and a ‘just me’ or single user display mode 242 (FIG. 21), as indicated in the bar at the top of the viewport. In this embodiment, comparison of the screens shows that many people have provided input (such as voted) in the Boston/Cambridge area, but the current user has only provided input in the Cambridge area.

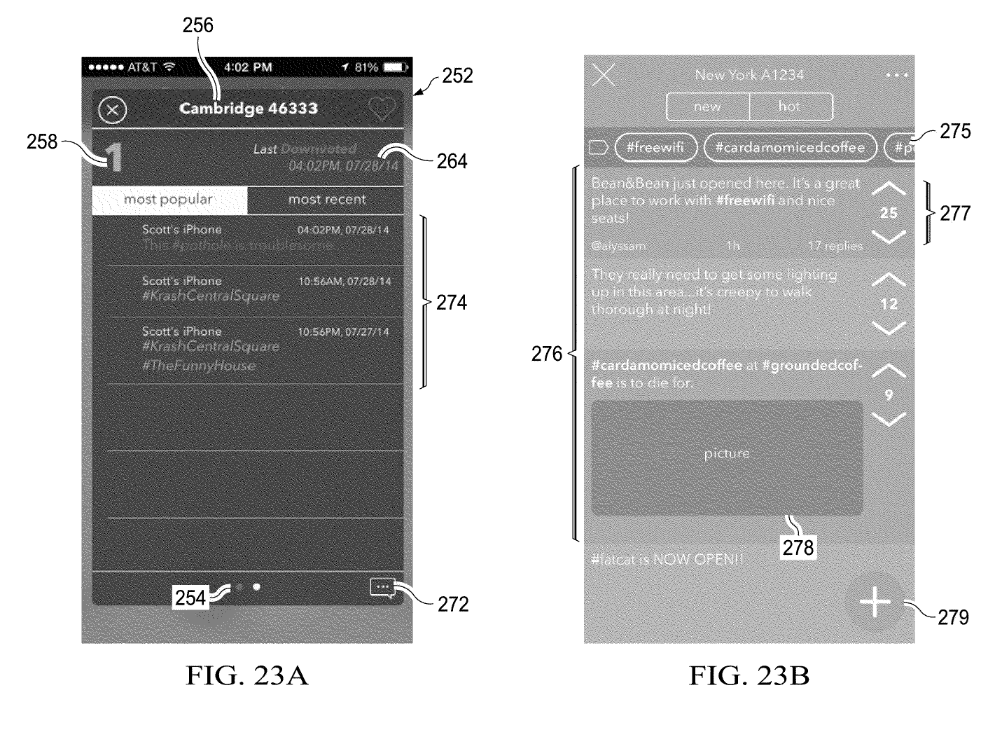

In some embodiments, while a user is interacting with the grid at the lowest zoom level, a user may tap on a base tile (such as tile 44 of FIG. 2) to show one or more tile windows 250 containing all of the information entered into that tile. Such information may be retrieved by the application from a database associated with a central server (such as that of the discussion platform or third-party platform), or provided from local device-stored data. In the embodiment of FIGS. 22 and 23, two windows 250 and 252 show the information as indicated by two dots 254. In other embodiments, a third window (not shown) may be used to show further photos or images associated with that tile. These windows may be set by the service as the home screen of that particular tile window (also called ‘pixel windows’). The window may display the tile name 256, score 258, distance from the user 260, coordinates 262, last activity information 264, relevant #tags 266 and images 268, and/or advertisements 270. In some embodiments, a user may be provided with options 272 to share the tile or information of or about the tile with other users (such as through a social network), or bookmark the tile. In the second tile window 252 (FIG. 23A), a user may be shown tile content, such as the comments/replies/#tags 274, in greater detail. The tags may be sorted by popularity, the time they were inputted, and/or qualitative values.

In other embodiments, the tile content may be organized and shown as the initial tile window, such as may be seen in FIG. 23B. As may be seen in that embodiment, a tile window may provide a marquee of tags 275 for easy user reference, as well as various comments and replies 276. The tile window may display vote symbols and vote tallies 277 for each comment and/or reply. If a comment contains media 278, then a thumbnail of the media may be provided. Tapping or clicking on the media may open a separate window or media player to allow a user to view the media. A user may be presented with an “add” button 279 to allow the user to provide a comment or reply, or post media or other information.

If a user is interacting with the grid at a zoom level higher than the lowest zoom level, a user may tap on an aggregate tile (called a ‘parent pixel’) to show one or more windows containing the information entered into the all of the base tiles represented by the aggregate tile. For example, at zoom level two, an aggregate tile window may present the information of four base tiles. At zoom level three, the aggregate tile window may present information of sixteen base tiles.

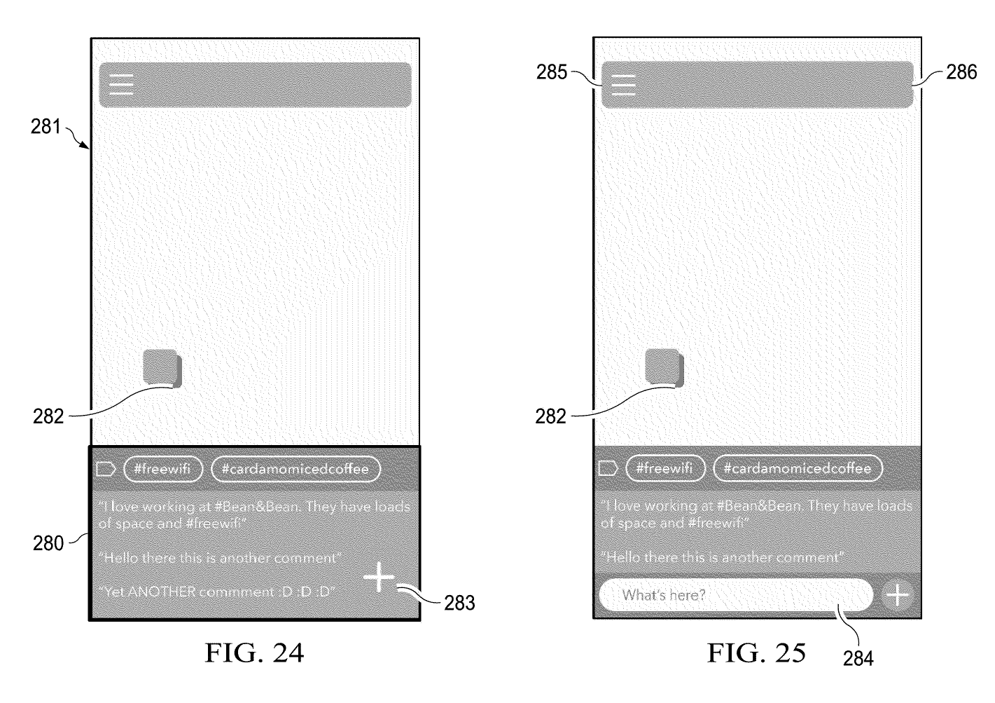

In some embodiments, a tile window may be visible to a user at all times, or at certain times, or may be triggered by certain events. For example, a tile window may automatically pop up when the user reaches a certain zoom level. The tile window may comprise a portion of the viewport. For example, depending on viewport orientation, the tile window may be provided at the bottom of the screen, or as a side bar. The tile window may comprise a preview or summary of information contained in or linked to the tile. For example, as may be seen in the embodiment of FIG. 24, a tile window 280 may be provided at the bottom of a viewport 281, and may provide tags and a summary of comments, such as the most popular or most recent comments with respect to the tile of interest 282. A user may be provided with an “add” button 283 to allow for quick comment entry. Or, as may be seen in the embodiment of FIG. 25, a user may be provided with a comment field 284 to allow the user to directly type comments into window. Further, the system may also provide quick menu links 285 and search fields 286.

The tile window or other notification may, in some embodiments, pop up when a cursor hovers over the tile, or when a user maintains a sustained touch on a touch screen, or when screen space allows, or based on other criteria, such as searches or filters. The tile window may be relatively transparent to allow a user to see the underlying map. The tile window may be shaped as to correspond with the shape of the tile to which it is linked, or to correspond with the shape of the group of tiles to which it is linked. In yet other embodiments, a tile window or other notification may pop up automatically when the system detects that the user has remained in the same location, or has remained relatively motionless for a certain amount of time. In yet further embodiments, when provided on location- and/or motion-sensitive mobile devices, a tile window comprising a part of the screen may present one or more thumbnail images (such as “street-view” images), tags and/or text provided by the user, by other users, by all users, and/or by a third-party platform, that may zoom or scroll depending on the user's orientation. In some embodiments, a tile window may comprise directions, such as turn-by-turn directions to a particular destination. The tile windows may be colored or shaded to reflect the user's zoom level.

In place of a tile's home screen, other content may be shown in a tile window that is constantly visible on a screen, such as comments or replies. Such content may change depending on the user's orientation or particular location within a tile. In some embodiments, the tile window may provide some type of call to action, such as a call to engage with the application. For example, a tile may be pre-filled with a question or suggestion to encourage user input, such as a silly question that may be fun to answer (e.g., “What is Balto looking at today?” if the user is in Central Park, New York), or a point-of-interest suggestion (e.g., “Bring gum for Post Alley!” if the user is in Seattle), or a question designed to validate data (e.g., “Is this really here?”).

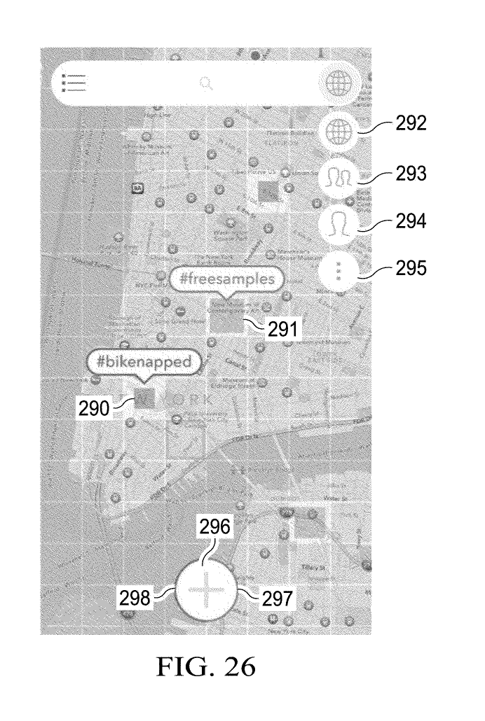

In yet further embodiments, an underlying map may be filtered by a specific category (e.g., music, sports, recreation), or tags, or provided in special mode which visualizes nearby aggregated local events or offers (e.g., free samples, or meetup.com or New Yorker events), or provide sub-categories/events/partnerships with eventing publishers like meetup.com or boston.com. For example, as may be seen in the embodiment of FIG. 26, various tiles may be shown that correspond to certain tags. A tile 290 may be tagged, for example, as unsafe due to bikenapping. Or, a tile 291 may be tagged as having stores offering free samples. A user may toggle further filter options, such as an option 292 for viewing tags or information by all users, an option 293 for viewing tags or information by some users such as friends, or an option 294 for viewing tags or information by only that user. To further ease user interaction, the application may provide further search or filter options 295, or make tag suggestions, and provide auto-tagging or auto-detection if a user is a participant in a category (such as may be set by the user as part of the user's profile). A user may also be presented with options to add comments or other information 296, or an upvote 297 or a downvote 298.

The application may also provide, or allow a user to select, a variety of visual indicators and animations such as pulsing, flashing, and scaling. The application may use various pixel searching techniques, such as based on location and context correlation. The application may further correlate searches to a given location, correlate keyword relevancy to a specific location.

In yet further embodiments, a variety of pixel voting techniques may be used. For example, the application may allow vote or information sharing between similar locations (location correlation), different distributions for voting (e.g., a score does not have to be linear), automatic vote degradation (e.g., over time, where older votes receive less weight, or an excessive amount of vote in a given time window are given less weight due to potential abuse of the service; or by user popularity, where the votes of less frequent users are given less weight), or vote limitations (e.g., limiting the number of votes by a user for a given tile within a certain time window).

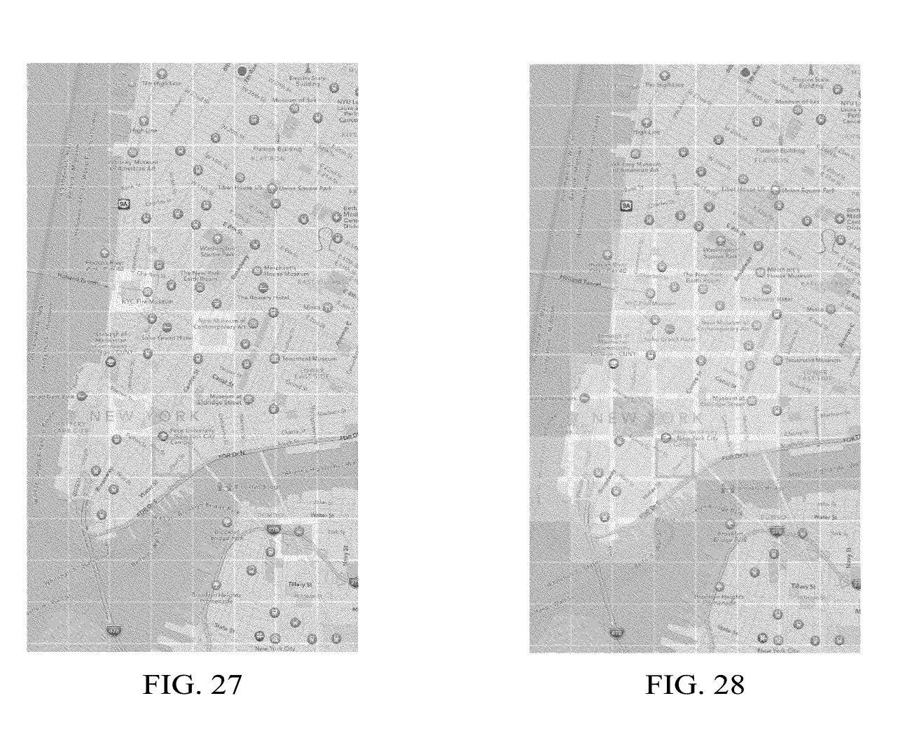

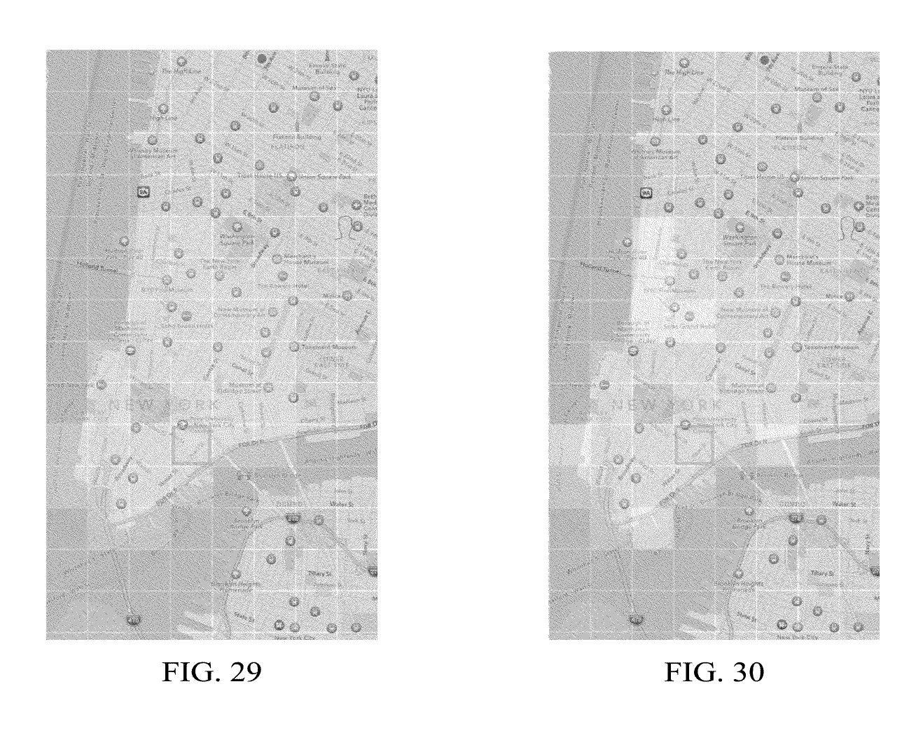

In some embodiments, a tile may be visually altered according to the type and frequency of activity associated with the tile. For example, a user comment or reply may “light up” a tile for a week, after which time the tile may gradually fade back to a neutral color. Similarly, higher-activity tiles or more information-dense tiles may be brighter in color or shade than surrounding tiles, or may be provided with a thicker border or different color altogether. The tiles may thus form a ‘heat map’ of user activity and/or information, as may be seen in the embodiment of FIGS. 27, 28, 29 and 30, which illustrates an example time progression as user votes and/or activity may light up various tiles in a map, and subsequent fading due to diminished user voting and/or activity.

In other embodiments, the service may be enhanced by data from other sources and services, and/or by aggregation and analysis of user data. For example, a user may auto-import certain data, such as user profile information from another social network, such as TWITTER messaging service. In other embodiments, government or third-party data may be imported, such as a travel advisory, Amber alert or weather information. A user may be provided with options to customize pixel images. The service may integrate with third-party mapping services, and import tags, descriptions and other metadata from such services. Data may be cleaned, de-duplicated and normalized for use in the service. User data may be analyzed to detect trends based on keywords, tags, traffic, travel patterns, and other data, and detect correlations within such data and between such data and data from other sources. Such data may be used to better target advertising to users. The service may thus be viewed as a platform for social engagement with respect to geographic regions provided around an underlying data collection and visualization service. The service may interpret, organize, and distill vast amounts and varieties of information into a consistent, approachable format that is enjoyable to use. The service may combine this data and format with a social feedback component for users to easily generate new sets of data. It may be thought of as a social geographic information system (GIS) having mass appeal.

Thus, various features as described above may be provided by the service to a user. As may be understood from the foregoing, a tile-based approach to regional geographic social discussion and discovery may be used to receive user input. However, a tile-based approach to regional geographic discussion or discovery need not include or be limited to user input. A tile-based approach may be used to aggregate and present a variety of data in a variety of formats as described herein. Data from third-party platforms, such as YELP® crowd-sourced review service or government databases, may be interpreted, organized and presented on or through the tiles, all without user input. Each place pixel and pixel window may be used to present information. For example, one or more tiles, such as at or near the boundary of a UI, may be used to provide advertising. In other examples, a tile (or pixel window associated with the tile) corresponding to an urban area relatively dense with restaurants may contain one or more advertisements for the restaurants in the area, such as a timed rotation or scrolling marquee of advertisements. Thus, the tile-based UI may be monetized in a variety of ways. For a tile-based UI provided in a 3D perspective, for example, one or more of the ‘sides’ (or thickness) of the tiles (such as ‘floating’ tiles), or the sides of the columns may contain one or more advertisements or other information, which may be visible to the user depending on map orientation (rotation and elevation) with respect to the UI.

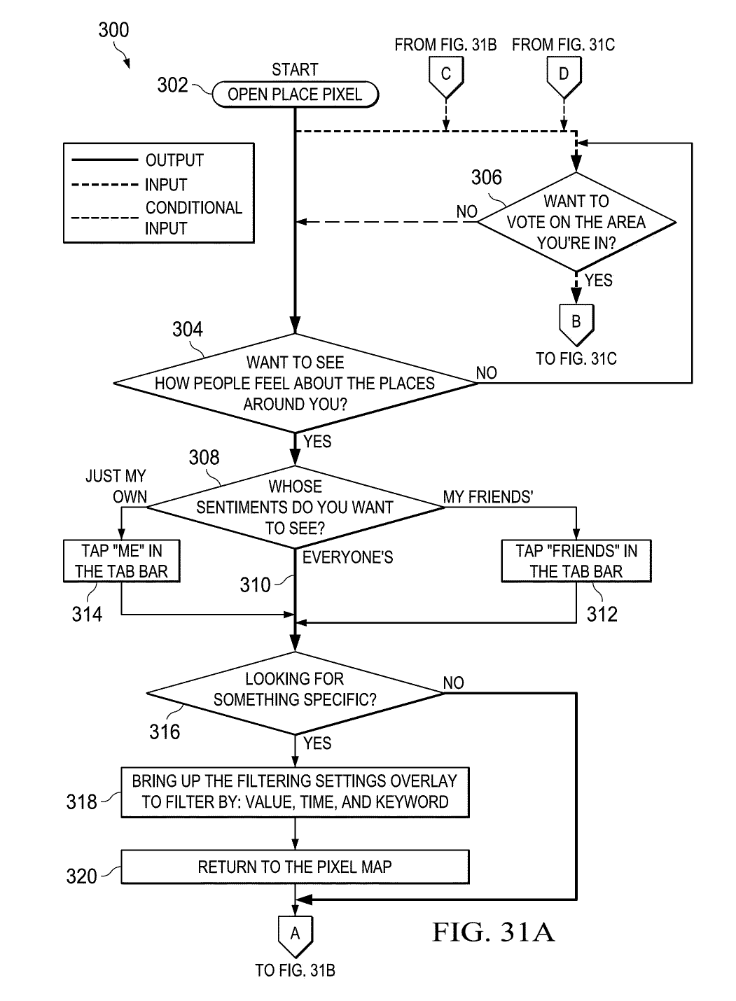

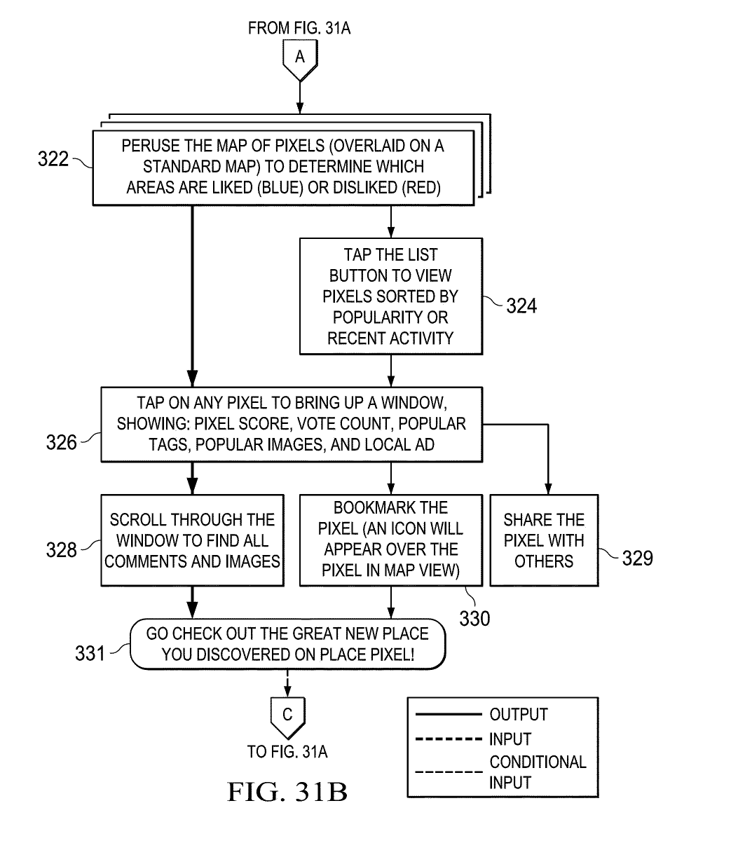

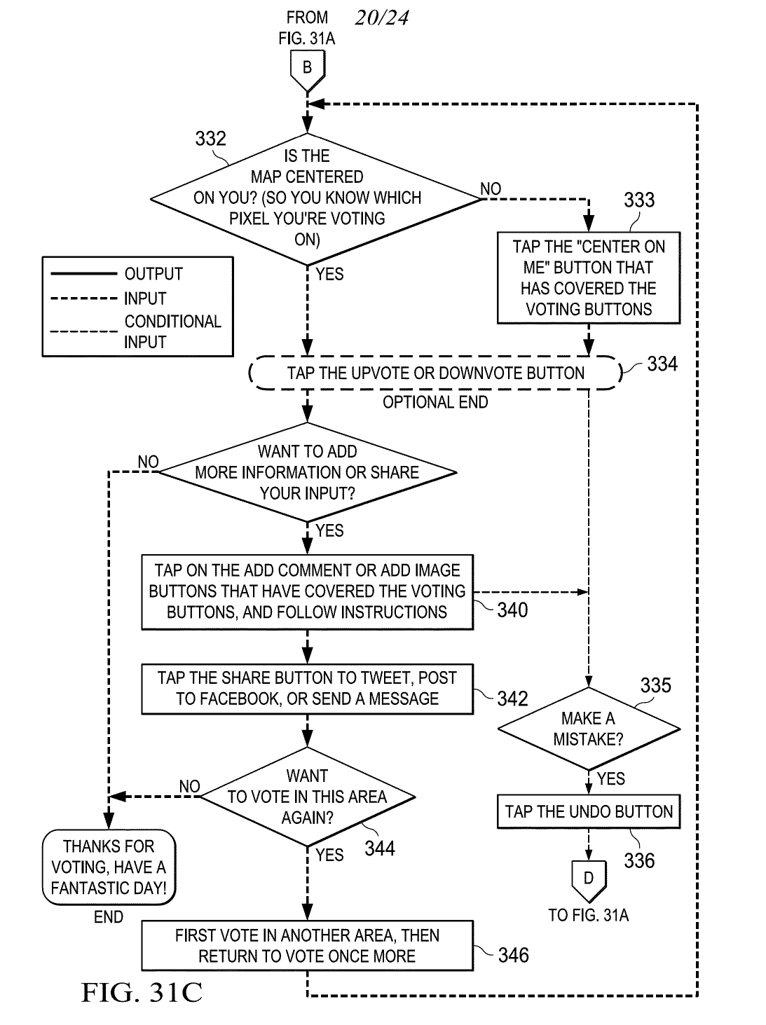

One example of a flow of user interaction with an application provided by the service may be seen in FIGS. 31A, 31B and 31C. This embodiment focuses on voting as a user input, but other types of user input may be used, as well, such as providing comments, questions, replies, emoji, links, or media. In the example method 300, a user may start the application at step 302. A user may, for example, decide to view how users feel about the user's location or surrounding location, or any other location covered by the application, at step 304. If the user does not want to view how other users feel about a location, then the user may, in step 306, decide to input information and/or vote on the user's location to indicate the user's feeling about that location. Alternatively, the user may decide 306 to input information and/or vote on the user's location without deciding whether to view other users' information and/or votes about an area. If the user does want to view how other users feel about a location, then the user may, in step 308, determine which user sentiments to view. For example, a user may choose to view all user sentiment (default view), or view the sentiment of the user's friends or connections 312 or just the user's own feelings about a location 314 by selecting the appropriate application option.

The user may further choose to filter which items to view at step 316. If some embodiments, the user may interact with a filter menu to filter the view by value, time and/or keyword, at step 318. Once a selection is made, then the user may return to the main place pixel map at step 320 to view the filtered results. The user may view the place pixel map to determine user sentiment at step 322. In some embodiments, the ‘liked’ place pixels may be shaded blue, and the ‘disliked’ place pixels may be shaded red. The user may view various portions of the place pixel map and adjust filter settings as desired. The user may also view a list of place pixels sorted by popularity in step 324. Generally, the user may view place pixel details by tapping or selecting the place pixel of interest, at step 326. At step 328, the user may scroll through one or more screens of place pixel information.

In some embodiments, a user may tell other users about a location of interest (step 329), and/or may bookmark a pixel for later reference (step 330). Having virtually explored the place pixel through the application, the user may further physically explore the location corresponding to the place pixel, at step 331. The user may, after further exploration, decide to provide user input, or vote on the location represented by the place pixel, at step 306. If the user decides to vote, for example, then the application may ensure that the user is voting with respect to the desired place pixel by allowing the user to center the pixel of interest in the viewport of the device on which the application is running, at step 332. If the desired place pixel is not centered in the device, then the user may center the desired place pixel at step 333.

The user may vote on the centered place pixel at step 334. In some embodiments, the application may allow a user to recognize a mistaken or regretted vote (step 335), and undo that vote (step 336).

In some embodiments, a user may provide information regarding the location by selecting one or more ‘add’ options (step 340) that may allow a user to comment and/or reply on the location, or add photographs of the location, or tag the location. Such ‘added’ information may be linked to the place pixel corresponding to the location. In some embodiments, the application may allow a user to recognize mistaken or regretted information (step 335), and undo that information addition (step 336). In other embodiments, a user may share the information with other users or via other social media platforms, at step 342.

A user may further be presented with the option to vote again on the location. At step 344, if a user desires to vote again on a location, the application may require that the user first move to a second location and vote before returning to the first location and voting (step 346). Such a requirement may discourage abuse of the voting process and result in more reliable vote results.

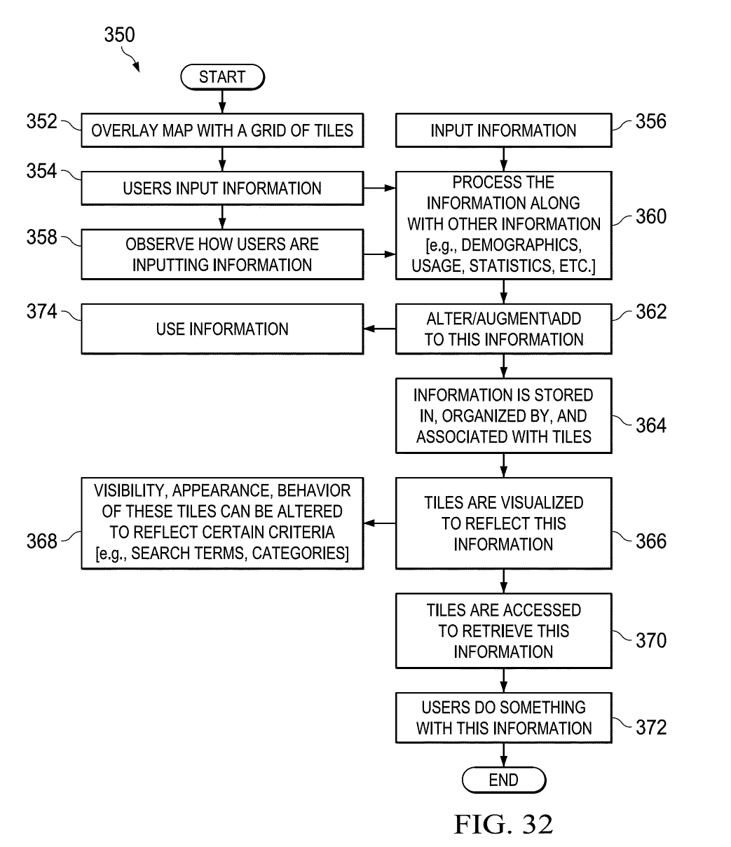

From the service provider's point of view, a variety of process flows may be utilized. One example of a process flow may be seen in FIG. 32. The process flow 350 of FIG. 25 may be described in connection with the various steps. In step 352, the service may provide a map having a grid overlay to form a plurality of tiles. A human-readable, memorable, and/or communicable naming convention may be used for these tiles. As zoom levels are navigated on the map, the service may dynamically aggregate or divide the tiles to represent larger or smaller geographic areas (e.g., four tiles become one tile, or one tile becomes four tiles). Such aggregation and division may help keep visualization within comfortable ranges for usability, and may allow the user to define the physical extents of the information for viewing. In some embodiments, the Mercator map projection may be used. In some embodiments, the tiles may be divided and subdivided down to 4 regions (over and over again). Each tile may be uniquely identified internally by concatenating its X and Y coordinates to form a unique sequence of numbers and letters for any combination of tile and zoom levels that exist. The tile format may be used to organize advertising opportunities. For example, the service may reserve space within the popup window associated with each tile for the placement of ads. These spaces may be bid out to potential customers (winner takes all/winner takes proportion), among other monetization strategies. The service may also reserve space for ads within other areas of the user interface, such as the ‘friend feed’ or ‘list view,’ among others.

In step 354, users may associate the information they input with the aforementioned tiles (representing geographic areas of space). The application may provide user interfaces and mechanisms to input this information. This information may include, but is not limited to: user's location, time of input, a vote value, tags, comments, replies, and images. Through the user interface, the service may encourage certain kinds of inputs. For example, the service may suggests the use of certain (popular) tags by visualizing them in a certain way. User input structure may include a vote, which automatically includes time, location, and vote value (in one embodiment, an upvote or downvote), and supplemental information such as a comment with #tags and an image. The service may make the information that users input compatible with the formats of other platforms. User cheating may be prevented by, for example, requiring a user to be located in the geographic area pertaining to the tile that he/she is voting on in order to encourage authenticity, and preventing a user from repeatedly spamming votes in a single tile. Errors may be prevented by ensuring user awareness of the tile he/she is currently in before casting a vote. The user may share his/her input to other platforms through the application.

In step 356, the service may process and organize information from third-party sources (such as advertising, tags and identifiers), then add that information into custom tile units. The service may take many disparate formats of information (from different sources) and normalize them into a common format. The service may add data that the service itself generates. The service may selectively insert or delete information based on the service's vision/priorities. The service may either mimic user behavior, or convey information in other ways (e.g., push notifications). The service may conduct error/abuse prevention, and may moderate inputted information. Essentially, the service may take large amounts of complex information, and distill it down into the foregoing visualization methodology (visualized tiles serving as containers of information, aggregation, animation), to create a consistent presentation that is easier for users to understand.

In some embodiments, the system may provide one or more artificial users in order to generate user interest, and to model potential user behavior. The system may aggregate data and curate information so as to “seed” the platform with new and compelling content. By doing so, the service may remain a useful resource in the absence of high user activity. In some embodiments, certain content may be given a default personality. For example, instead of just listing the location of public toilets, an artificial user or personality profile may be applied, e.g., to create a George Costanza-like persona that goes about adding those locations and providing mock “reviews.”

In step 358, the service may monitor users' activity, taking note of not only what they do, but how they do it. This may be used to provide users with more predictive, useful information, faster. Information that people do not ‘consciously’ input, but that are nevertheless meaningful, may include: frequency of input, demographic information, activity history, the person's social connections, etc. While a user is using the application, or the application is running on the user's mobile device, the service may identify the user's location and vote history. The service may also keep track of the user's location and movement inside and outside of buildings. This info may be used for path detection algorithms (e.g., Google INGRESS™ game) used by the service.

In step 360, the service may create “scores” for each tile based on user input (e.g., vote value). These scores do not necessarily need to be the sum of vote values; the service may score pixels based on a variety of value systems. For example, multiple votes from the same source may count less towards the overall score. Votes may all be aggregated and stored with metadata such as time, location, user identity, etc. Tags, comments, replies, and other inputs may be stored with metadata; all or some of which may be associated with categories that may be used for generic search and tagging. Users may be grouped with their friends to store an aggregate profile. Associations may be made among all or part of this information; preferably, all of the data gets “crunched.” The data can be updated in real time, or at set intervals. The service may keep track of trending locations/regions/tags and visualize them on the map in real-time. Users may keep information about their past inputs/searches.

In step 362, the service may add advertisements; may convert information in order to make it compatible with other platforms, e.g., TWITTER® messaging service; may organize the information and display it in ways to produce certain effects, e.g., the user finding what he/she wants, as fast as possible, or to make more information easier to consume; and/or may filter the information. Space may be reserved within each tile window for the placement of ads. These ads may be populated intelligently based on the information collected.

In step 364, information may be stored in, organized and/or associated with tiles. Tile information may be update in real time, or at set intervals. Each base tile and its parent tiles may be updated in an online fashion such that the parent tiles may only infrequently or never have to recompute their tile scores.

In step 366, for example, tiles may be visualized to reflect their total vote score, or their popularity, or the presence of a bookmark. Or, the tiles may pulsate or flash when activity is conducted within them. Visualization categories may include, but are not limited to color, size, shape, symbols, animations, and other effects, such as sounds. Visualization may include popup content boxes and preview window displays. The information may be referenced to a specific geographic area or the bounds of the screen through which the user is viewing the application. Thus, the application may allow for the interpretation of information in a novel way. The service may also implement a list view, which sorts the tiles according to popularity and recent activity.

In step 368, the visibility, appearance, and/or behavior of the tiles may be altered to reflect certain search criteria. Search criteria may include, but are not limited to tags, comment contents, time, vote value, intensity of value, frequency of input, categories, location, image properties, source of the information, e.g., from everyone, or just your friends. Tiles may be removed altogether. The information may be referenced to a specific geographic area or the bounds of the screen through which the user is viewing the application.

In step 370, tiles may be accessed to retrieve this information. A user may tap on a tile (or parent tile) to bring up a window that displays the information associated with it. This information may be filtered, organized, and augmented by the service. The user may rearrange how this information is display based on certain criteria, such as popularity and recent activity. An ad impression may be created each time a tile window is accessed. Other elements of the user interface, such as the friend feed, or the list view, may be used to display advertisements or sponsored information.

In step 372, users may share or bookmark the information. Users may convert the information into value in other contexts, such as ‘visiting a location found in our application and enjoying a deal, or even a nice view.’ Users may respond to the information, e.g., upvoting/downvoting comments and images, or creating new content that references the information.

In step 374, the service may, among other things: create real time ‘heat maps’ of the information on a map, associate tags and categories to locations/regions that can be useful for third-party integration, share the information through other channels and formats (e.g., mailings), summarize the information for advertisers and other consumers, sell access to the information, create third-party APIs/integration, implement machine learning/trending/data mining, and create correlations.

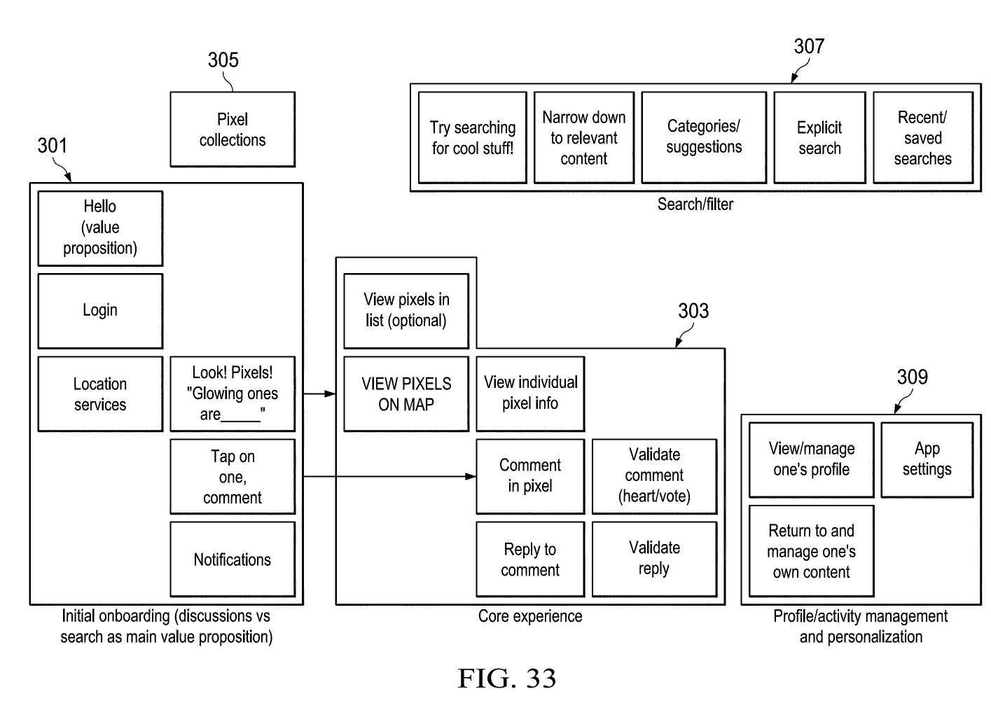

Thus, using a tile (pixel) methodology of visualization allows for the organization and consumption of information in a far simpler way. As may be seen in FIG. 33, information, processes and features may be grouped in convenient ways. For example, various user on-boarding processes 301 may be provided, depending on whether the platform is configured primarily for social interaction or for discovery for a given user. A user may be presented with a login screen and an option to enable location services. A user may be presented with a map overlaid with place pixels, and be presented with a variety of interaction means and notifications. A user may interact with the platform in a variety of ways 303, such as by viewing tiles or tile lists, viewing tiles overlaid on a map, viewing tile information, providing comments and replies, and providing validation or sentiment. The interactions may draw from and further enrich the tile collection and related information 305. A user may be provided with various search and filter tools 307, and personalize the user experience by various user tools 209.

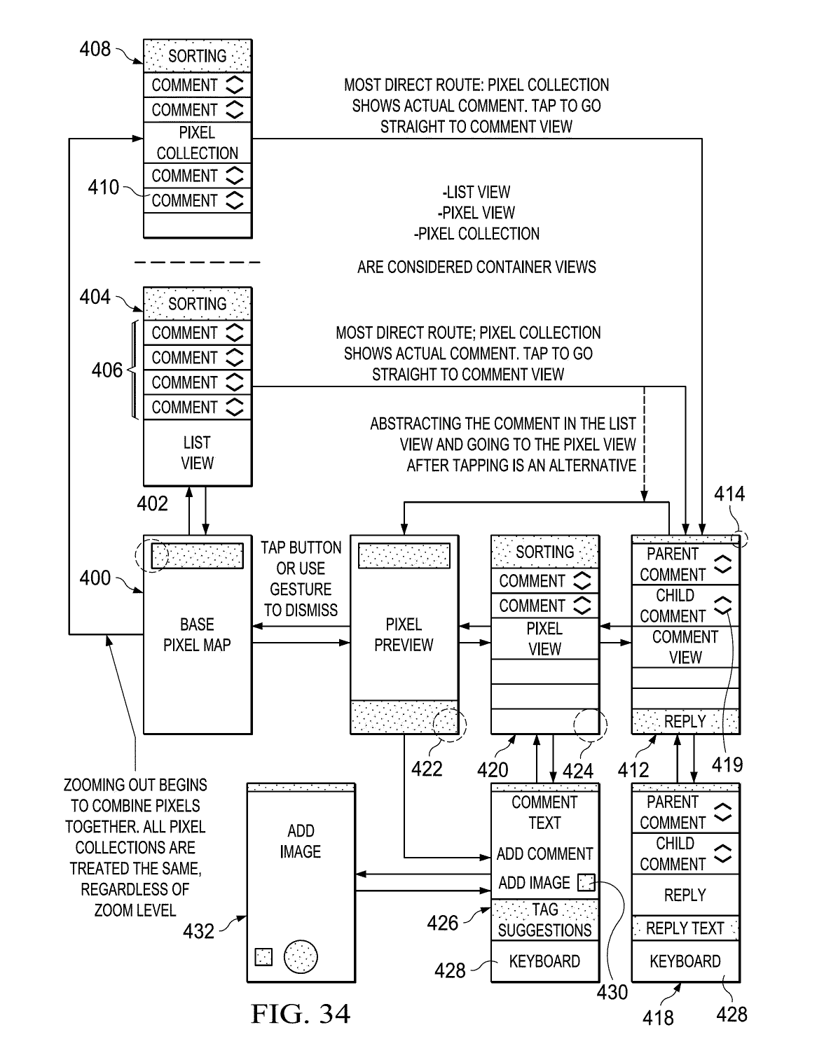

One or more various ways of interaction 303 are further illustrated in the embodiment of FIG. 34. As may be seen in that embodiment, a user may, from a base pixel map 400, toggle other views of pixels using a menu 402. For example, a user may toggle a list view 404 of pixels, along with related comments 406. A user may toggle a pixel collection view 408, showing an aggregation of pixels and related comments 410, such as those presented at higher zoom levels. As a user zooms out, various pixels may begin to aggregate as described above, resulting in one or more pixels that are a collection of other pixels. Pixel collections may be treated similarly regardless of zoom level, or may be treated differently depending on zoom level. For example, each zoom level may be color coded, and that color coding used through the various pixel views at that zoom level.

From either of those views, a user may go to a comment view 412 by tapping on a comment. The comment view may arrange the selected comment and replies by popularity, or freshness, or other criteria. A user may, upon reading the comments, decide to use a menu option 414 to preview pixel information in a preview screen 416. Or, a user may elect to add a comment or reply in a reply view 418. A user may also use the upvote and downvote arrows 419 to register sentiment regarding the comment.

If the user chooses to preview the pixel using the preview screen 416 (which may be similar to screens of FIG. 24 or 25), the user may, after previewing the pixel, go to a pixel view 420 to see further pixel information and related comments. A user may choose to add comments using a menu 422 or 424. If adding comments, a user may be presented with a comment field screen 426, in which a user may add a comment or tag. On some devices, an on-screen keyboard 428 may be displayed to permit touch-based text entry. In some embodiments, a user may add media, such as a photo or video or symbol, to the comment, using a media button 430. A media button 430 may take a user to a media screen 432, which may allow a user to append an image from a library, or use a camera to record new media.

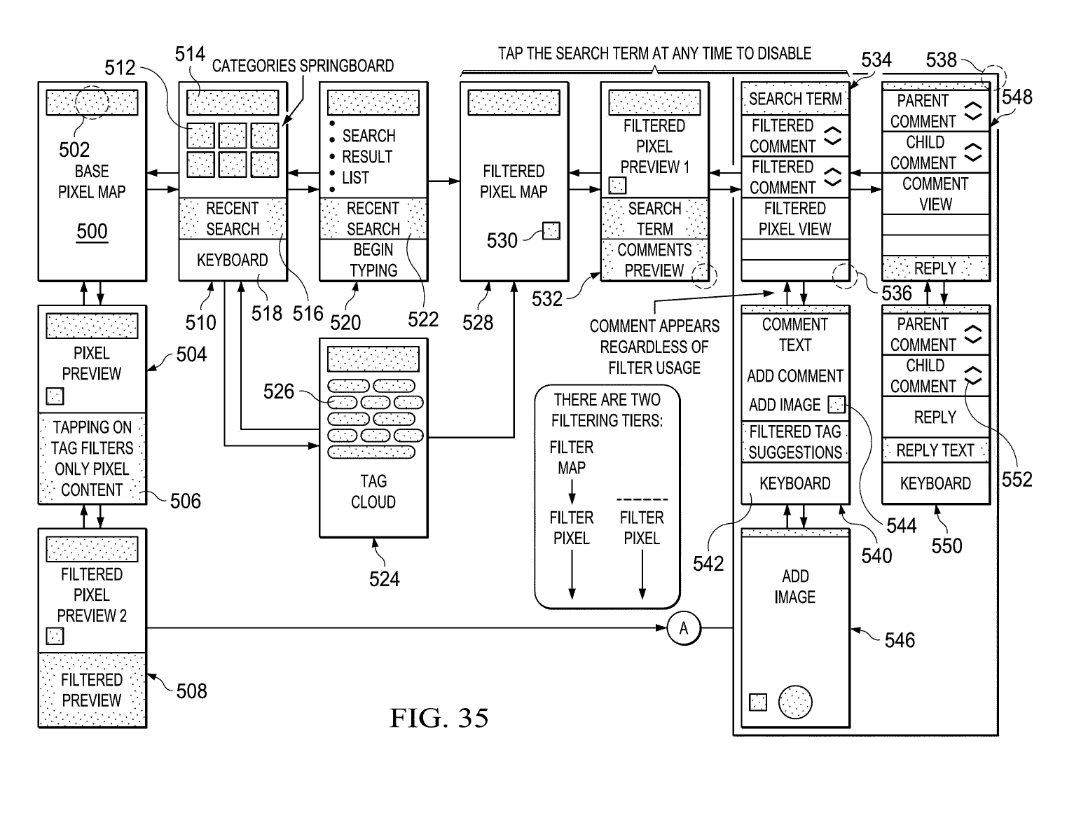

One or more search and filter tools are illustrated in the embodiment of FIG. 35. In some embodiments, two primary filtering tiers may be provided: a map filter and pixel filter. Thus, a user may filter the map and/or filter pixels. A user may, for example, be presented with a base pixel map 500. Through interaction with a menu 502, a user may be presented with a pixel preview screen 504. The pixel preview screen 504 may display one or more tags 506. A user may select a tag to filter on, which may take a user to a filtered preview screen 508. A user may then interact with application to provide and view comments, replies and/or media, as described in connection with box “A.”

In other embodiments, a user may select a category view screen 510 through interaction with a menu 502. The categories may be presented as pixels, or images, or text, or symbols or other indicia 512. A user may search for categories using a search field 514, and view recent searches 516. A keyboard 518 may facilitate category searching. User search results may be conveniently arranged in a search results screen 520, along with recent search results 522.

If a user selects a category 512, the user may be presented with a tag cloud screen 524. A user may select one or more tags 526 to further filter the search results.

After searching and/or filtering, a user may be presented with a filtered pixel map 528. A user may select a pixel 530 from the map, such as by touch. The user may then be presented with a filtered pixel preview screen 532. The user may then interact with application to provide and view comments, replies and/or media, as seen in box “A.” A user may tap a search term at any time to disable the search screen and return to the base pixel map.

As may be seen in box “A,” if the user chooses to preview the pixel using the preview screen 508 or 532 (which may be similar to screens of FIG. 24 or 25), the user may, after previewing the pixel, go to a filtered pixel view 534 to see further pixel information and related comments. A user may choose to add comments using a menu 536 or 538. If adding comments, a user may be presented with a comment field screen 540, in which a user may add a comment or tag. On some devices, an on-screen keyboard 542 may be displayed to permit touch-based text entry. In some embodiments, a user may add media, such as a photo or video or symbol, to the comment, using a media button 544. A media button 544 may take a user to a media screen 546, which may allow a user to append an image from a library, or use a camera to record new media.

A user may also go to a comment view 548 by tapping on a comment. The comment view may arrange the selected comment and replies by popularity, or freshness, or other criteria. A user may, upon reading the comments, decide to use a menu option 538 elect to add a comment or reply in a reply view 550. A user may also use the upvote and downvote arrows 552 to register sentiment regarding the comment.

The tile-based approach may be used with a social, spatial discovery platform, for people to discover and/or communicate with one another about areas. The tile visualization approach provides a very easy to understand a uniform grid that is very scalable. Phenomena may be organized within the bounds of each tile, retaining a very clean, simple interface. Such visualization avoids incomprehensible, overlapping markers found in other location-based systems. Users may evaluate neutral areas of space rather than, say, venues, giving all phenomena within the bounds of that space equal weight in the discussion. The tiles may be visualized a certain way, e.g., changing colors, sizes, shapes, adding symbols, and animating, to convey certain information. The tiles convey hierarchy easily. The tile method of representation (starting with all the tiles darkened, and coloring them when activity occurs) conveys a feeling of discovery, of ‘lighting up the world’, or ‘popping bubble wrap’, or ‘bringing to life’ rather than ‘adding’ (the tiles are already there, but latent, rather than a map being empty, without a marker). Thus, it becomes very easy for technology to identify which geographic tile a user is currently occupying the tiles can aggregate as you zoom further away; they combine to represent summations of the levels underneath them. Such a methodology may provide users with a feeling of discovery and geographically-based social engagement.

Although the disclosed subject matter and its advantages have been described in detail, it should be understood that various changes, substitutions and alterations can be made herein without departing from the invention as defined by the appended claims. Moreover, the scope of the claimed subject matter is not intended to be limited to the particular embodiments of the process, machine, manufacture, composition, or matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods or steps.

We claim:

1. A method of geographic social interaction comprising:
providing a map representing a geographic area;
overlaying the map with a grid, the grid comprising a plurality of tiles, each tile being associated with a unique portion of the geographic area; and
receiving input from a first user in connection with one of the plurality of tiles (“first selected tile”).

2. The method of claim 1, wherein the input from the first user comprises a comment regarding the portion of the geographic area associated with the first selected tile.

3. The method of claim 2, further comprising receiving input from a second user in connection with the first selected tile.

4. The method of claim 3, wherein the input from the second user comprises a reply to the comment.

5. The method of claim 3, wherein the input from the second user comprises an upvote or a downvote on the comment.

6. The method of claim 1, further comprising altering the visual appearance of the first selected tile based on the input from the first user.

7. The method of claim 3, further comprising altering the visual appearance of the first selected tile based on the input from the second user.

8. The method of claim 1, wherein the input from the first user comprises at least one of a photo, a video, a symbol, an emoji, and a hyperlink.

9. The method of claim 1, further comprising providing first selected tile information to the first user in response to the input from the first user, the first selected tile information comprising information regarding the portion of the geographic area associated with the first selected tile.

10. The method of claim 1, further comprising providing a filtered view of the map in response to the input from the first user.

11. The method of claim 10, wherein the filtered view excludes input from any user other than the first user.

12. The method of claim 10, wherein the filtered view includes only one or more visual indicators related to the input from the first user.

13. A method of geographic discovery comprising:
providing a map representing a geographic area;
overlaying the map with a grid, the grid comprising a plurality of tiles, each tile being associated with a unique portion of the geographic area;
detecting a location of a first user;
identifying the location of the first user on the map with respect to a first user tile, the first user tile being one of the plurality of tiles;
receiving a first input from a first user in connection with a first selected tile, the first selected tile being one of the plurality of tiles; and
in response to the first input, providing first selected tile information to the first user in response to the first input, the first selected tile information comprising information regarding the portion of the geographic area associated with the first selected tile.

14. The method of claim 13, wherein the first selected tile is the first user tile.

15. The method of claim 13, further comprising altering the visual appearance of the first selected tile based on the first input.

16. The method of claim 13, wherein the first input comprises a comment regarding the portion of the geographic area associated with the first selected tile.

17. The method of claim 13, wherein the first input comprises an upvote or a downvote on the first selected tile.

18. The method of claim 15, further comprising:
receiving a second input from a second user regarding the first selected tile; and
further altering the visual indication in the first selected tile based on the second input.

19. The method of claim 13, further comprising:
receiving a second input from a second user regarding the first selected tile; and
altering the first selected tile information based on the second input.

20. The method of claim 13, further comprising:
receiving a magnification input from the first user;
if the magnification input comprises a ‘zoom out’ instruction, then rescaling the grid such that at least two of the plurality of tiles aggregate into a single parent tile, the single parent tile being associated with the unique portions of the geographic area associated with the at least two of the plurality of tiles; and
if the magnification input comprises a ‘zoom in’ instruction, then rescaling the grid such that at least one of the plurality of tiles divides into a plurality of child tiles, each child tile being respectively associated with a unique sub-portion of the unique portion of the geographic area associated with the at least one of the plurality of tiles.
